(19) United States
(12) Patent Application Publication
(10) Pub. No.: US 2020/0170452 A1
(43) Pub. Date: Jun. 4, 2020

(54) GROOVIE BOARD

(71) Applicant: RONALD N. SWANK, NAMPA, ID (US)

(72) Inventor: RONALD N. SWANK, NAMPA, ID (US)

(21) Appl. No.: 16/702,460

(22) Filed: Dec. 3, 2019

Related U.S. Application Data
(60) Provisional application No. 62/774,667, filed on Dec. 3, 2018.

(51) Int. Cl. A47J 47/00; A47J 47/08

(52) U.S. Cl. CPC A47J 47/005; A47J 47/08

(57) ABSTRACT

A cutting board having an integrated channel having openings integrated in the channel to allow for liquid from a food being cut on the board to collect in the channel and flow downward to a receptacle, such as a pan, to collect. The underside of the cutting board has a groove configured to mount the cutting board on the lip of a pan to retain the cutting board on the pan when the cutting board is in use.

### PRIORITY/CROSS-REFERENCE TO RELATED APPLICATIONS

This application claims the benefit of U.S. Provisional Application No. 62/774,667, filed Dec. 3, 2018, the disclosure of which is incorporated by reference.

### TECHNICAL FIELD

The disclosure generally relates to the field of cutting boards and food containers utilized in food preparation.

### BACKGROUND

In preparing food cutting boards are often utilized as a surface on which a food is cut. For example, a cooked piece of meat is often cut into serving proportions on a cutting board after the meat has been cooked. The cooked meat typically contains juices. When the meat is sliced these juices tend to drip or drain from the meat onto the surface on which the meat is being cut. This can make a mess if the juices drain from the surface of the cutting board onto a table or counter on which the cutting board is being used. Further, a cook will often desire to use the drippings for making a sauce or other food dish. What is needed is an improved mechanism for collecting the juices from the slicing of the meat or other food item for easy disposal or further use.

### SUMMARY OF THE INVENTION

The purpose of the summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the inventive concept(s) of the application, which is measured by the claims, nor is it intended to be limiting as to the scope of the inventive concept(s) in any way.

What is disclosed is cutting board system having a receptacle configured to retain a liquid. The cutting board system has a lid configured for mating engagement with the rim of the receptacle. The lid preferably has a channel on a first side of the lid configured for mating engagement with the rim of the receptacle. The lid preferably has a cutting board surface with a continuous channel. The continuous channel preferably has openings through the lid such that a liquid within the channel flows from the channel through the openings into the receptacle.

In a preferred embodiment, the cutting board system has a second lid configured to cover the receptacle. The continuous channel preferably has at least two openings and filters configured to cover the openings to prevent or catch food matter from entering the receptacle.

In a preferred embodiment, the lid and the receptacle are generally circular. In an alternate embodiment the lid and receptacle are a geometric shape with at least three sides.

In a preferred embodiment, the first lid, the second lid, and the receptacle are configured for being packaged into a single unitary piece.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the description of the preferred embodiments are to be regarded as illustrative in nature, and not as restrictive in nature.

### BRIEF DESCRIPTION OF THE FIGURES

FIG. 1 depicts a top perspective view of a preferred embodiment of a round cutting board lid.

FIG. 2 depicts a top perspective view of a preferred embodiment of a round cutting board lid held in an open position above a pan.

FIG. 3 depicts a top perspective view of a preferred embodiment of a rectangular cutting board lid.

FIG. 4 depicts a top perspective view of a preferred embodiment of a rectangular cutting board lid held in an open position above a pan.

FIG. 5 depicts a top perspective view of a preferred embodiment of a lid of a system incorporating a cutting board having grooves for mounting to a pan.

FIG. 6 depicts a side perspective view of a preferred embodiment of a lid, cutting board, and pan of a system incorporating a cutting board having grooves for mounting to a pan.

### DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

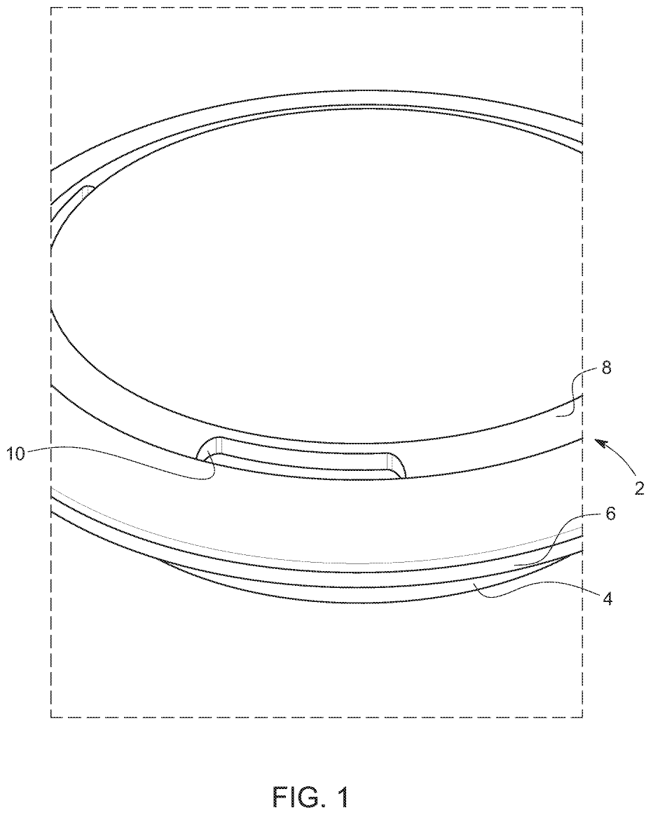

FIG. 1 depicts a top perspective view of a Groovie Board 2 mounted to a pan 4. The cutting board has a surface having a circumference 6. The cutting board has a channel 8 within the periphery of the cutting board for the collection of liquid from the surface of the board. The channel utilizes openings 10 that allow liquid to flow from the channel to the pan or receptacle beneath the cutting board.

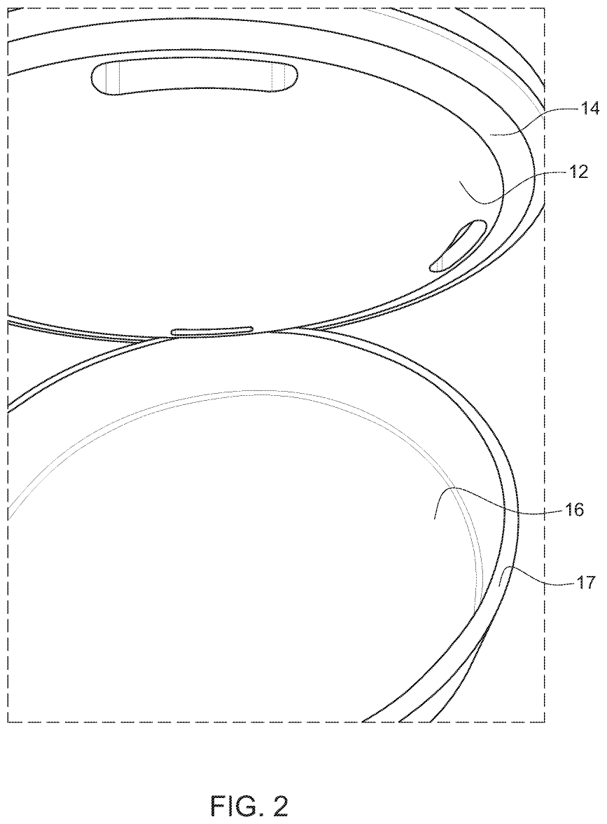

FIG. 2 depicts a partially exploded view of a Groovie Board and receptacle. FIG. 2 depicts a partially exploded view of a cutting board lid 12 and container 16. The cutting board lid underside 12 has a groove 14 configured such that the groove rests on and matingly engages with the rim 17 of the receptacle. This allows for the cutting board to rest securely on the rim of the receptacle while in use. A user can cut or slice food on top the cutting board with the juices running down into the receptacle.

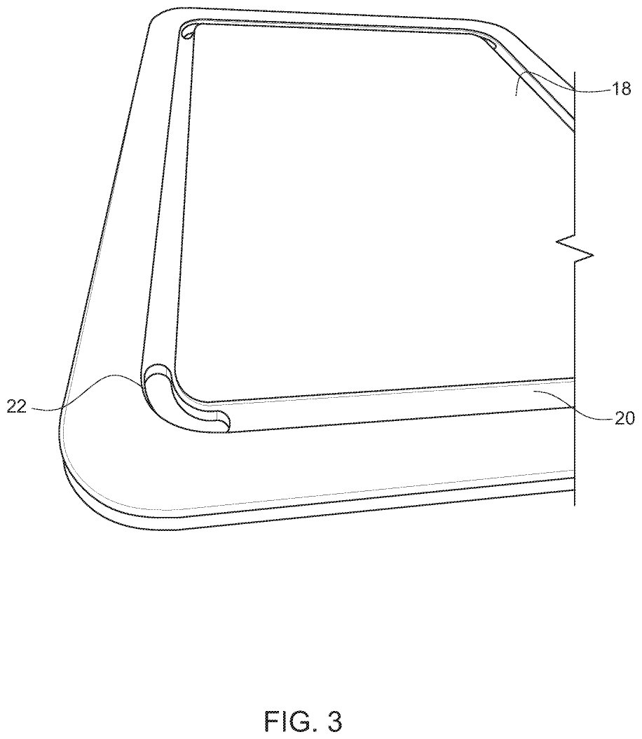

FIG. 3 shows an alternative rectangular embodiment of a cutting board lid. The rectangular cutting board is configured to fit on a container shown in FIG. 30. The container can be of a variety of materials including but not limited to a metal pan such as aluminum, a glass pan such as Pyrex®, or any other pan or container for receiving the juices of a food item that is cut. FIG. 3 depicts a generally rectangular channel 20 that functions similar to a moat in allowing for the liquids to drain into the channel and through the openings 22, and into the receptacle. The service 18 of the cutting board is preferably made out of a cutting board surface such as a plastic or wood.

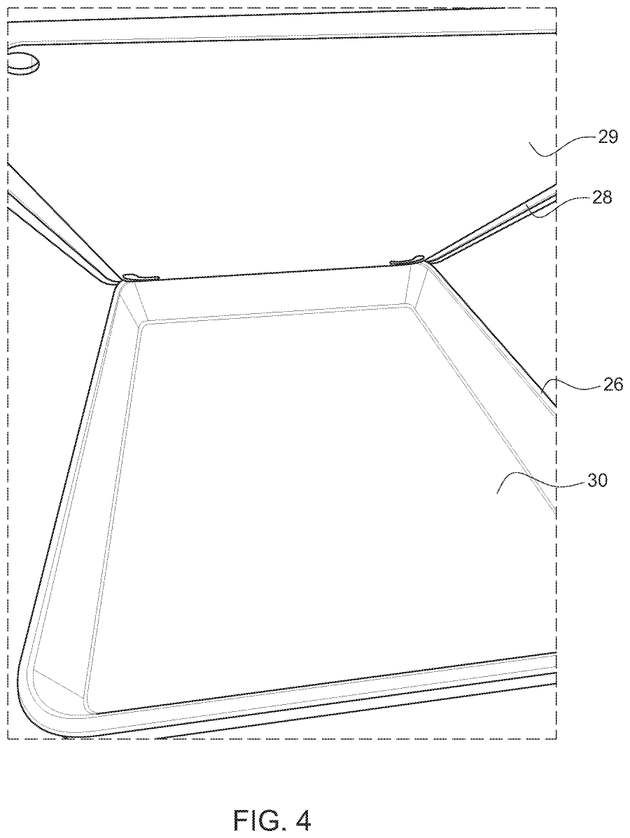

FIG. 4 is a partially exploded view of the rectangular embodiment of FIG. 3, showing the underside 29 of the cutting board. The underside of the tray utilizes a channel 28 that is configured to rest upon or matingly engage the rim 26 of the pan or receptacle 30.

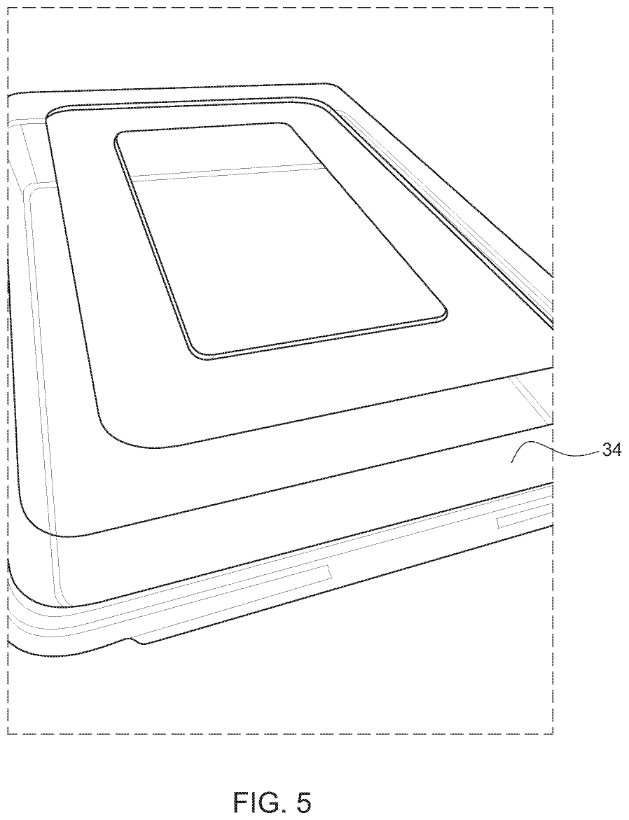

FIG. 5 illustrates an optional lid 34 that can be included with the cutting board and pan. The lid is configured for mounting or attachment to the top of the pan.

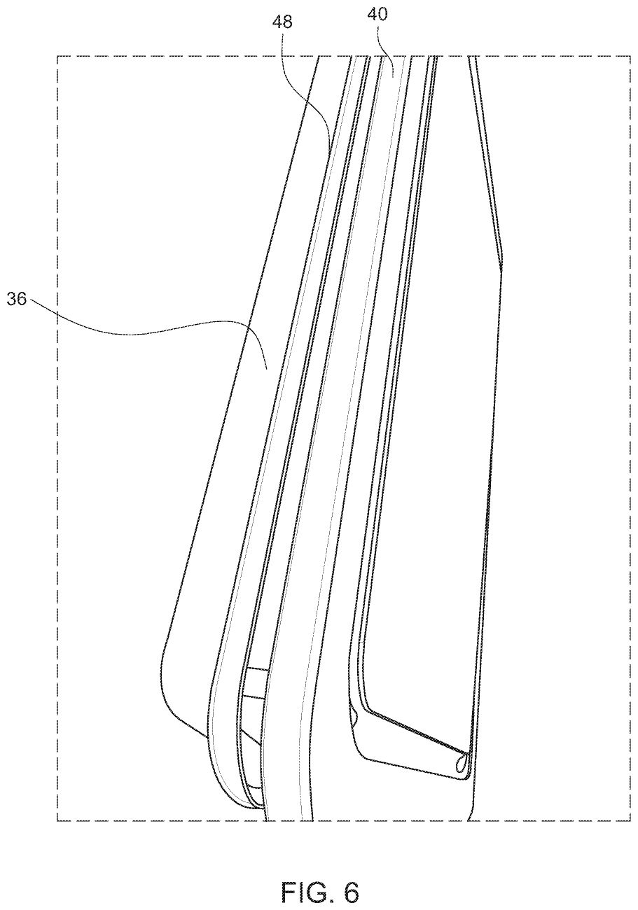

FIG. 6 illustrates a preferred embodiment of the Groovie Board shown utilizing the optional lid 36 in which the pan 48 is retained. The cutting board or lid 40 is retained to the top of the pan. The entire package can then be shrink-wrapped or packaged and sold as a package.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

What is claimed is:

1. A cutting board system comprising:
a receptacle wherein said receptacle is configured to retain a liquid;
a lid, wherein said lid is configured for mating engagement with a rim of said receptacle, wherein said lid comprises a channel on a first side of said lid configured for mating engagement with said rim of said container, wherein said lid comprises a cutting board surface;
wherein said cutting board surface comprises a continuous channel, wherein said continuous channel comprises openings through said lid such that a liquid within said first surface channel flows from said channel through said openings into said receptacle.

2. The cutting board system of claim 1, wherein said system comprises a second lid configured to cover said receptacle.

3. The cutting board system of claim 1, wherein said continuous channel comprises at least two openings.

4. The cutting board system of claim 1, wherein said continuous channel comprise filters configured to cover said openings.

5. The cutting board system of claim 1, wherein said lid and said receptacle are generally circular.

6. The cutting board system of claim 1, wherein said lid and said receptacle comprise a geometric shape with at least three sides.

7. A cutting board system comprising:
a receptacle wherein said receptacle is configured to retain a liquid;
a first lid, wherein said first lid is configured for mating engagement with a rim of said receptacle, wherein said first lid comprises a channel on a first side of said lid configured for mating engagement with said rim of said container;
wherein said first lid comprises a cutting board surface, wherein said cutting board surface is configured as a cutting board surface, wherein said cutting board surface comprises a continuous channel, wherein said continuous channel comprises openings through said first lid such that a liquid within said continuous channel flows from said channel through said openings into said receptacle;
a second lid, wherein said second lid configured to cover said receptacle when said first lid is removed, wherein said first lid is configured for attaching to said second lid when said first lid is not in use.

8. The cutting board system of claim 7, wherein said continuous channel comprises at least two openings.

9. The cutting board system of claim 7, wherein said continuous channel comprise filters configured to cover said openings.

10. The cutting board system of claim 7, wherein said first lid and said receptacle are generally circular.

11. The cutting board system of claim 7, wherein said first lid and said receptacle comprise a geometric shape with at least three sides.

12. The cutting board system of claim 7, wherein said first lid, said second lid, and said receptacle are configured for being packaged as a single unitary piece.
